(19) United States
(12) Patent Application Publication
(10) Pub. No.: US 2019/0067720 A1
(43) Pub. Date: Feb. 28, 2019

(54) METHOD FOR PRODUCING A MEMBRANE-ELECTRODE ASSEMBLY AND MEMBRANE-ELECTRODE ASSEMBLY

(71) Applicants: AUDI AG; Volkswagen AG, Wolfsburg (DE)

(72) Inventor: Hannes SCHOLZ, Braunschweig (DE)

(21) Appl. No.: 15/770,704

(22) PCT Filed: Oct. 19, 2016
(86) PCT No.: PCT/EP2016/075071

§ 371 Date: Apr. 24, 2018

(30) Foreign Application Priority Data
Oct. 29, 2015 (DE) 102015221158.4

(51) Int. Cl. H01M 8/1004; H01M 4/88; H01M 8/0284; H01M 8/0276; H01M 8/0286

(52) U.S. Cl. CPC H01M 8/1004; H01M 4/8807; H01M 4/8892; H01M 2008/1095; H01M 8/0278; H01M 8/0286; H01M 8/0284

(57) ABSTRACT

The invention relates to a method for producing a membrane electrode assembly (10) for a fuel cell, comprising the following steps in the order given:
provide two gas diffusion layers (13) that each have a catalytically coated surface;
apply an ionomer dispersion (15a) onto the coated surface of at least one of the gas diffusion electrodes (13),
arrange the gas diffusion layers (13) on each other such that the coated surfaces face each other, and a layer stack (18) comprising a gas diffusion layer (13)-catalytic coating (14)-ionomer coating (15)-catalytic coating (14)-gas diffusion layer (13) arises, and
arrange a peripheral seal (17) around the layer stack (18), wherein the seal (17) has a height that at least corresponds to the height of the layer stack (18).

Furthermore, the invention relates to a membrane electrode assembly (10) that is or can be produced by means of the method according to the invention.

The invention relates to method for producing a membrane electrode assembly, as well as a membrane electrode assembly produced or producible by means of the method.

Fuel cells use the chemical conversion of a fuel with oxygen into water in order to generate electrical energy. For this purpose, fuel cells contain as a core component that is known as the membrane electrode assembly (MEA), which is an arrangement of an ion-conducting (usually proton-conducting) membrane and in each case a catalytic electrode (anode and cathode) arranged on each side of the membrane. The latter generally comprise supported precious metals, in particular platinum. In addition, gas diffusion layers (GDL) can be arranged on both sides of the membrane electrode assembly on the sides of the electrodes facing away from the membrane. Generally, the fuel cell is formed by a plurality of MEAs arranged in the stack, the electrical power outputs of which add up. Between the individual membrane electrode assemblies, bipolar plates (also called flux field plates) are usually arranged, which ensure a supply of the individual cells with the operating media, i.e. the reactants, and are usually also used for cooling. In addition, the bipolar plates ensure an electrically conductive contact to the membrane electrode assemblies.

During operation of the fuel cell, the fuel, especially hydrogen H₂ or a gas mixture containing hydrogen, is supplied to the anode over an open flux field of the bipolar plate on the anode side, where electrochemical oxidation of H₂ to H⁺ with loss of electrons takes place. A transport of the H⁺ protons from the anode chamber into the cathode chamber is effected via the electrolytes or the membrane, which separates the reaction chambers from each other in a gas-tight and electrically insulated manner (in a water-bound or water-free manner). The electrons provided at the anode are guided to the cathode via an electrical line. The cathode is supplied with oxygen or a gas mixture containing oxygen (such as air) via an open flux field of the bipolar plate on the cathode side, so that a reduction of O₂ to water (H₂O) takes place with uptake of the electrons and proteins.

In PEM fuel cells, a proton-conductive, gas-tight and electrically nonconductive layer is needed between the anode electrode and cathode electrode to ensure the functional principle. It is prior art to use polymer electrolyte membranes (PEM) for this. In so doing, membranes are employed that can be further processed as a separate component. These membranes are exposed to mechanical and thermal loads. Consequently, the membranes cannot be arbitrarily thin and arbitrarily loaded up with functional groups. Consequently, membranes according to the prior art cause significant voltage losses within the fuel cell as a consequence of the ohmic resistance of the proton conduction.

In order to circumvent the disadvantages of ionomer films, Klingele et al. developed a concept in which an ionomer layer is applied directly onto a gas diffusion electrode. (Klingele et al. J. of Mat. Chem. A; 2015; DOI: 10.1039/c5ta01341k). The concept of the directly applied ionomer layer is associated with more economical production capability, advantages when assembling fuel cell stacks, and smaller voltage losses due to the proton resistance, in particular during operation with low gas humidities. To avoid a mixture of operating gases between the gas diffusion layers, however, a subgasket is needed in the described concept that disadvantageously covers and hence deactivates a portion of the active surface. Moreover, the subgasket requires the ionomer layer and electrodes in the overlapping region to be pressed very strongly, which can cause damage.

The invention is based on the object of circumventing or at least reducing the disadvantages of the prior art. In particular, a membrane electrode assembly is provided that has both the advantages of an ionomer layer that can be applied as a liquid, as well as those of an ionomer film.

This object is achieved by a method for producing a membrane electrode assembly, as well as a membrane electrode assembly with the features of the independent claims. Accordingly, a first aspect of the invention relates to a method for producing a membrane electrode assembly for a fuel cell, comprising the following steps in the given sequence: First, two gas diffusion layers are provided that each have a catalytically coated surface. Then an ionomer dispersion is applied onto the coated surface of at least one of the gas diffusion electrodes (catalytically coated gas diffusion layer). After application of the ionomer dispersion, the gas diffusion layers are arranged on each other such that the coated surfaces face each other, and a layer stack results that comprises a gas diffusion layer with a catalytic coating, an ionomer coating arranged thereupon, a catalytic coating arranged thereupon on a gas diffusion layer. After the layer stack is formed, a peripheral seal is arranged around the layer stack according to the invention, wherein the seal has a height that corresponds at least to the height of the layer stack. In comparison to the use of conventional membrane films, the membrane electrode assembly produced according to the invention has the advantage that the membrane does not have to support itself, but rather is supported by the gas diffusion layer on which it is deposited. This can significantly reduce the thickness and hence the consumption of membrane material. Furthermore, by directly applying the membrane material in a liquid state onto the catalytic surface, the contact with the gas diffusion layer is optimized so that a transfer of hydrogen and current between the gas diffusion layer and membrane is increased. This is also associated with an elevated proton conductance for the membrane electrode assembly. In contrast to the known direct application method by Klingele et al., in the method according to the invention nearly the entire coated surface is accessible to the fuel cell reaction due to the peripheral seal, since what is known as a subgasket can be omitted that would functionally cover part of the ionomer layer and hence reduce the active surface. Accordingly, a membrane electrode assembly produced by the method according to the invention has a greater efficiency. Moreover, it is evident that a peripheral seal as provided according to the invention achieves better sealing results than a membrane electrode assembly with a subgasket. Moreover, the seal according to the invention does not require additional pressing of the membrane electrode assembly. A membrane electrode assembly produced according to the invention is accordingly distinguished over the prior art by a longer service life and greater efficiency.

In the present case, a membrane electrode assembly comprises two gas diffusion layers as well as two electrodes, namely anode and a cathode, wherein a respective electrode is arranged on a gas diffusion layer. The two gas diffusion layers are separated by a proton-conductive membrane within the membrane electrode assembly, which membrane is applied according to the invention in liquid form onto the catalytic coating of at least one of the gas diffusion electrodes. The membrane electrode assembly accordingly comprises a layer stack made up of a first gas diffusion layer, a catalytic coating arranged thereupon, a membrane arranged thereupon in the form of an ionomer coating, a catalytic coating arranged thereupon, which is in turn adjoined by a second gas diffusion layer.

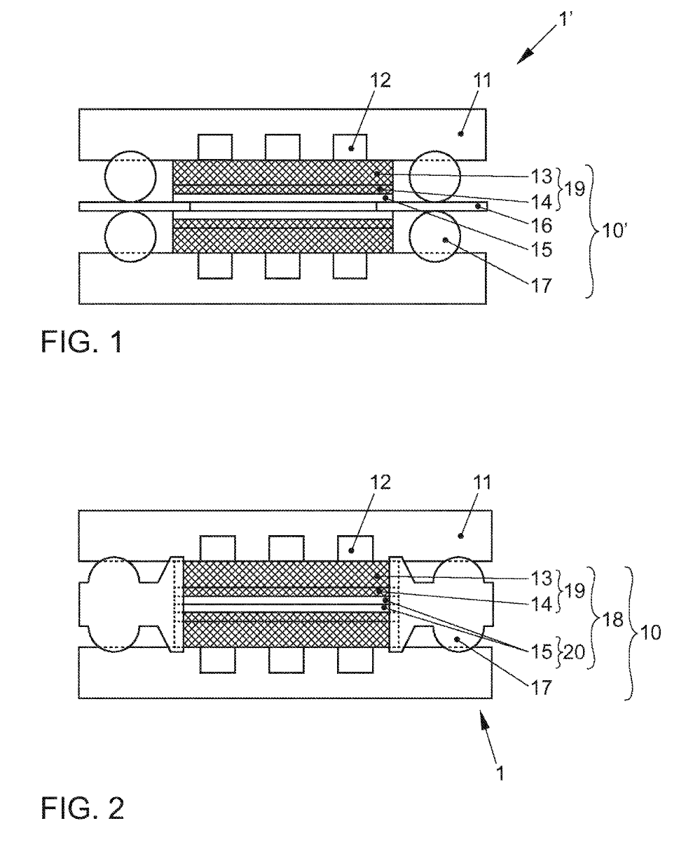

In the present case, a peripheral seal is understood to be a material that is arranged around the layer stack of the membrane electrode assembly. It is preferably an elastic material such as an elastomer or thermoplastic elastomer. The peripheral seal is designed as a single part, at least with regard to the height of the layer stack, i.e. it extends in height beyond the total height of the layer stack. With reference to a conventional membrane electrode assembly, the peripheral seal according to the invention accordingly combines two seals (see FIG. 1), namely an anode chamber seal and a cathode chamber seal, as well as a separating element that separates the anode chamber from the cathode chamber in conventional membrane electrode assemblies. Depending on the design of the conventional membrane electrode assembly, this separating element is either the subgasket or a membrane film, or rather the support frame of a membrane film that respectively projects beyond the surface of the gas diffusion layer.

A preferred embodiment of the invention provides that the peripheral seal is an injection-molded seal. This is a particularly simple method that can in particular be applied subsequently, i.e. after the layer stack is built up. In the injection molding method, it is particularly advantageous that error tolerances while building the membrane electrode assembly can be compensated by the peripheral seal, and a particularly effective sealing result is accordingly achieved.

Particularly advantageously, the ionomer dispersion is applied to the gas diffusion electrode by means of an inkjet method since the best results have been achievable therewith to date, in particular with regard to homogeneity and layer thickness. Alternatively, the ionomer dispersion is applied by means of spraying, printing, rolling, coating or doctoring.

It is particularly preferable to apply an ionomer coating to each catalytically coated surface of both gas diffusion layers. The advantage is that a greater contact surface and hence lower contact resistances are achieved at both electrodes. In this embodiment, the proton conductivity and yield within the membrane electrode is therefore further improved. Alternatively, the catalytically coated surface of only one of the two gas diffusion electrodes is provided with an ionomer coating and is arranged on the catalytically coated surface of the second gas diffusion layer. The advantage of this embodiment is in particular a saving of material.

Advantageously, an ionomer layer forms between the catalytic coatings of the two gas diffusion electrodes which, depending on the embodiment of the method according to the invention, comprises the ionomer coating of one of the gas diffusion layers, or the ionomer coating of both gas diffusion layers. Particularly advantageously, this ionomer layer is in contact with the catalytic coating of both gas diffusion layers. In other words, a layer stack is formed from a first gas diffusion layer-first catalytic coating-ionomer layer-second catalytic coating-second gas diffusion layer, wherein all layers are arranged on each other with frictional engagement. In particular, no macroscopic cavities form between the layers that would reduce the proton, or rather electric, conductivity within the membrane electrode assembly. Accordingly, the service life and efficiency of the membrane electrode assembly is optimized in this embodiment.

It is in particular preferable for the entire ionomer layer to be in contact with the catalytic coating of both gas diffusion electrodes, and in particular not to be interrupted by sealing material such as a subgasket.

Advantageously, the ionomer dispersion comprises a polymer electrolyte, in particular Nafion. This dispersion medium is preferably a mixture of water, alcohol and ether, in particular a mixture of water, propanol, ethanol, and at least one ether. The dispersion preferably comprises 5 to 45% by weight of the polymer electrolyte, in particular 10 to 35% by weight of the polymer electrolyte, preferably 15 to 30% by weight of the polymer electrolyte. It was shown that such dispersions can be applied well and uniformly to the gas diffusion electrodes using the aforementioned method, in particular using the inkjet method, and a contiguous and high quality ionomer layer is thereby generated on the corresponding gas diffusion layer.

Another aspect of the invention relates to a membrane electrode assembly produced or producible according to the method according to the invention.

Accordingly, the invention relates in particular to a membrane electrode assembly that comprises two gas diffusion layers, wherein each of the gas diffusion layers has a surface coated with a catalytic material, and at least one of the gas diffusion layers on the catalytically coated surface has an ionomer coating to form an ionomer layer. The two gas diffusion layers are arranged relative to each other such that the catalytically coated surfaces face each other and are separated from each other by the ionomer layer. According to the invention, the ionomer layer is in contact with the catalytic coating of both gas diffusion layers.

The ionomer layer comprises at least one ionomer coating on one of the gas diffusion electrodes. Optionally, the ionomer layer also comprises another ionomer coating that is arranged on the second gas diffusion electrode. The ionomer coating is preferably applied to the gas diffusion electrode by means of an ionomer dispersion in liquid form as described in the method according to the invention.

Moreover, the invention relates to a fuel cell having a membrane electrode assembly according to the invention.

Additional preferred embodiments of the invention arise from the remaining features mentioned in the dependent claims.

The various embodiments of the invention mentioned in this application may be combined advantageously with one another unless stated otherwise in individual cases.

The invention is explained below in exemplary embodiments in reference to the associated drawings. The following is shown:

FIG. 1 a schematic representation of the cross-section of a fuel cell according to the prior art,

FIG. 2 a schematic representation of a cross-section of a fuel cell according to a preferred embodiment of the invention, and

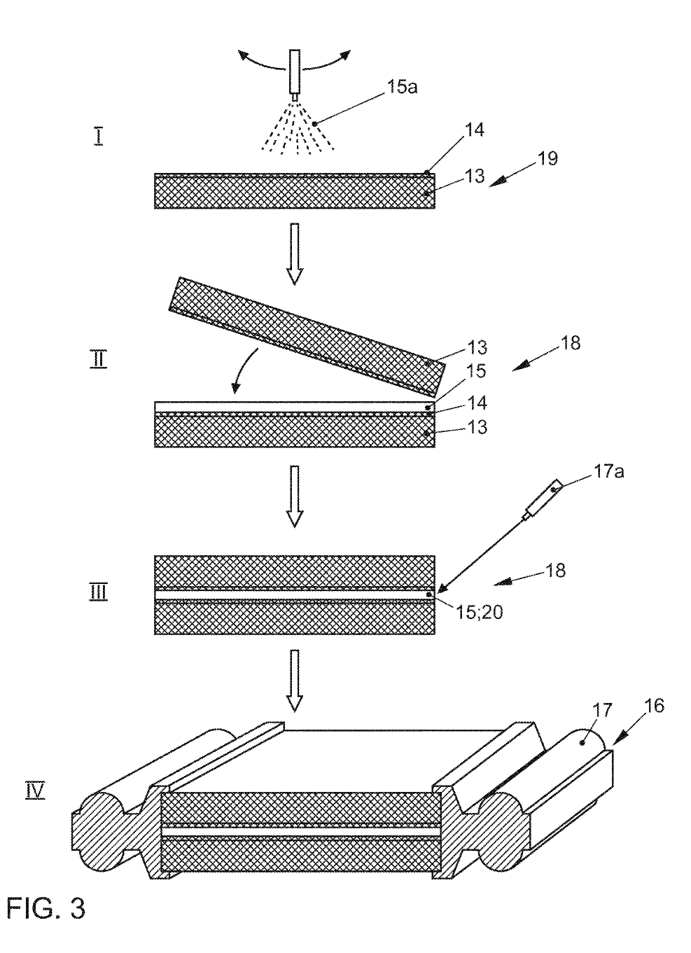

FIG. 3 a schematic flow chart of a method for producing a membrane electrode assembly according to a preferred embodiment of the invention.

FIG. 1 shows a schematic representation of a cross-section of a fuel cell 1′ according to the prior art. The fuel cell 1′ according to the prior art comprises two bipolar plates 11 that have reactant flow channels 12 to conduct oxidant, or rather fuel. A membrane electrode assembly 10′ according to the prior art is arranged between the two bipolar plates. The membrane electrode assembly 10′ comprises two gas diffusion layers 13 that have a catalytic coating 14 on one of their surfaces. In the membrane electrode assembly 10′ according to the prior art, the two catalytically coated gas diffusion layers 13 are arranged so that the coated surfaces face each other. An ionomer is arranged between the coated surfaces that separates the two gas diffusion electrodes from each other gas-tight. The ionomer is either designed as an ionomer coating 14 as shown in FIG. 1 that is applied to each catalytic coating of the two gas diffusion layers 13. To separate the gas compartments, a subgasket 16 is then provided that separates the two gas compartments from each other. Alternatively (not shown here), the ionomer is designed as an ionomer film that is arranged between the gas diffusion electrodes 19. In this version, the ionomer film is either designed significantly larger than the surface of the gas diffusion electrode 19, so that it projects beyond the two gas diffusion electrodes 19 in a layer stack consisting of a gas diffusion electrode 19 ionomer and gas diffusion electrode 19, or the ionomer film is encompassed in a support frame that then for its part projects beyond the gas diffusion electrodes 19. Depending on the embodiment, the protrusion serves to separate the gas compartments of the two gas diffusion electrodes 19.

The ionomer coating 14 of the two gas diffusion electrodes 19 of the fuel cell 1′ shown in FIG. 1 does not contact each other in the membrane electrode assembly 10′ according to the prior art, but is rather separated by the subgasket 16. A gap is created.

In contrast, FIG. 2 shows a cross-section of a fuel cell 1 according to the invention. The fuel cell 1 comprises two bipolar plates 11 that in turn have flow channels 12 to supply a membrane electrode assembly 10 with operating gases. The membrane electrode assembly 10 is arranged between the two bipolar plates 11 and comprises two gas diffusion electrodes 19 between which an ionomer layer 20 is arranged. The gas diffusion electrodes 19 each comprise a gas diffusion layer 13 as well as a catalytic coating 14 deposited on their surface. The ionomer layer 20 comprises at least one ionomer coating 15 that is deposited on a catalytic coating 14 of one of the gas diffusion electrodes 19. In the shown embodiment, the ionomer layer 20 comprises two ionomer coatings 15, wherein one is deposited on each of the gas diffusion electrodes 19. Deposition can occur for example by means of the method according to the invention, for example, which will be described in greater detail with reference to FIG. 3.

It can be seen in FIG. 2 that a fuel cell according to the invention does not have a gap between the gas diffusion electrodes 19. In particular, no macroscopic cavities or gaps arise between the layers of the layer stack 18 of a first gas diffusion electrode 13 with catalytic coating 14, an ionomer layer 20, and a second catalytic coating 14 that in turn is arranged on a second gas diffusion electrode 13. A material bond arises instead of a friction bond. This is in particular realized in that the fuel cell 1 according to the invention does not have a separating layer between the gas diffusion electrodes in the form of a subgasket, a membrane film or a membrane frame. Instead, a sealing material, 17 for example in the form of an injection-molded seal, is arranged between the bipolar plates 11, peripherally around the layer stack 18. This sealing material extends beyond the total height of the layer stack 18. The sealing material layer is arranged in an integrally bonded manner on the side edges of the layer stack 18 so that no operating gases can escape from the gas diffusion layers, and in particular cannot mix. This means that the peripheral seal 18 prevents an exchange of substances between the gas diffusion layers, in which it enables essentially no fluid-conducting connections between the gas diffusion layers. The sealing material 17 is a polymer seal, for example, in particular an elastomer or a thermoplastic elastomer. As further shown in FIG. 2 in comparison to the prior art the peripheral seal 17 according to the invention combines two seals, that each are arranged between a bipolar plate and the separating layer 16, with the separating layer into a single seal 17.

The membrane electrode assembly 10 according to the invention is designed as shown in FIG. 2, for example, such that the layer stack 18 in the membrane electrode assembly 10 has no or as few as possible macroscopic cavities, however in any case no gaps, that would reduce the proton conductivity or the current conductivity across the membrane electrode assembly.

Moreover, the combination of three sealing elements as used in the prior art into a single peripheral seal 17 as provided according to the invention is associated with fewer interfaces, and is accordingly not only easier to produce but also displays better sealing results.

FIG. 3 shows a schematic flow chart of a method according to the invention for producing a membrane electrode assembly 10 in a preferred embodiment. In a first step I in the flowchart, a gas diffusion electrode 19 is provided that comprises a gas diffusion layer 13 which has a catalytic coating 14 on one of its surfaces. A liquid ionomer dispersion 15a is applied thereupon. For example, this can be done by means of an inkjet printing method, spraying, brushing, rolling, doctoring or the like.

The dispersion comprises a polymer electrolyte, in particular Nafion, such as Nafion D2020. A mixture comprising water, alcohol, and ether can be used as the dispersant. For example a mixture comprising water, propanol, ethanol, and an ether mixture has proven to be advantageous. Positive results were able to be be generated with a dispersion that comprises approximately one part polymer electrolyte and two parts dispersant. Such a mixture is, for example, obtainable as DuPont's Nafion®) D2020 dispersion from Ion Power, that comprises 21% by weight Nafion, 34% by weight water, 44% by weight 1-propanol, 1% by weight ethanol, and an ether mixture.

The application of an ion ionomer mixture 15a onto a gas diffusion electrode 19 is known from a review article in the Journal of Material Chemistry A, von Klingele et al., to which reference is hereby made or that is referenced.

In a second step II, a second gas diffusion electrode 19 also comprising a gas diffusion layer 13 and a catalytic coating 14, is arranged on the ionomer coating of the gas diffusion electrode 19.

The gas diffusion electrodes 19 are aligned relative to each other such that the catalytic surfaces face each other. The layer stack 18 shown in the third step III arises which comprises gas diffusion layer 13, catalytic coating 14, ionomer coating 15 or rather ionomer layer 20, another catalytic coating 14 arranged therein which is arranged on another gas diffusion layer 13. Optionally, an ionomer coating 15 can also be applied onto the second gas diffusion electrode 19 and is connected to the ionomer coating 15 of the first gas diffusion electrode 19, preferably over its entire surface, when forming the layer stack 18.

According to the invention, a sealing material 17a is arranged peripherally along a side edge of the layer stack 18, beyond the total height of said side edge. For example, the sealing material 17a is preferably a polymer, in particular an elastomer or a thermoplastic elastomer. The sealing material 17a is, for example, applied by means of injection molding to the layer stack. After the sealing material 17a cures, the membrane electrode assembly according to the invention as shown in step IV arises with a peripheral seal 17. The seal 17 has a height that at least corresponds to the height of the layer stack 18.

### LIST OF REFERENCE SYMBOLS

1 fuel cell
1′ fuel cell according to the prior art
10 membrane electrode assembly
10 membrane electrode assembly according to the prior art
11 bipolar plate
12 reactant flow channel
13 gas diffusion layer
14 catalytic coating
15 ionomer coating
16 subgasket
17 seal
17a sealing material
18 layer stack
19 gas diffusion electrode (GDE)
20 ionomer layer

1. A method for producing a membrane electrode assembly for a fuel cell, comprising:
providing two gas diffusion layers that each have a catalytically coated surface;
forming an ionomer coating by applying an ionomer dispersion onto the catalytically coated surface of at least one of the gas diffusion layers;
arranging the gas diffusion layers adjacent to each other such that the catalytically coated surfaces of the gas diffusion layers face each other to produce a layer stack comprising the gas diffusion layers, catalytic coatings on the gas diffusion layers, and the ionomer coating; and
arranging a peripheral seal around the layer stack, wherein the seal has a height that at least corresponds to the height of the layer stack.

2. The method according to claim 1, wherein the peripheral seal is an injection-molded seal.

3. The method according to claim 1, wherein the ionomer dispersion is applied by an inkjet method onto the gas diffusion layer.

4. The method according to claim 1, wherein a respective ionomer dispersion is applied onto the catalytically coated surfaces of both gas diffusion layers.

5. The method according to claim 1, wherein an ionomer layer is formed between the catalytic coatings and is in contact with the catalytic coatings of both gas diffusion layers, and wherein the ionomer layer comprises the ionomer coating of one of the gas diffusion layers, or ionomer coatings on both gas diffusion layers.

6. The method according to claim 5, wherein the ionomer layer is in contact with the catalytic coatings of both gas diffusion layers over the entire surfaces of the catalytic coatings.

7. The method according to claim 1, wherein the ionomer dispersion comprises a polymer electrolyte.

8. A membrane electrode assembly produced or producible by a method comprising:
providing two gas diffusion layers that each have a catalytically coated surface;
applying an ionomer dispersion onto the catalytically coated surface of at least one of the gas diffusion layers to produce an ionomer coating;
arranging the gas diffusion layers adjacent to each other such that the catalytically coated surfaces of the gas diffusion layers face each other to produce a layer stack comprising the gas diffusion layers, catalytic coatings on the gas diffusion layers, and the ionomer coating; and
arranging a peripheral seal around the layer stack, wherein the seal has a height that at least corresponds to the height of the layer stack.

9. A membrane electrode assembly comprising:
two gas diffusion layers, wherein each of the two gas diffusion layers has a surface coated with a catalytic material to form a catalytic coating, and
an ionomer coating on the catalytic coating of at least one of the gas diffusion layers to form an ionomer layer, wherein the two gas diffusion layers with the catalytically coated surfaces are arranged to face each other and are separated from each other by the ionomer layer, the ionomer layer being in contact with the catalytic coatings of both gas diffusion layers.

10. A fuel cell having a membrane electrode assembly, the membrane electrode assembly comprising:
a layer stack including:
two gas diffusion layers that each have a catalytically coated surface;
an ionomer coating on at least one of the catalytic coated surfaces of the gas diffusion layers, wherein the gas diffusion layers are positioned adjacent to each other such that the catalytic coated surfaces of the gas diffusion layer face each other; and
a peripheral seal around the layer stack, wherein the seal has a height that at least corresponds to the height of the layer stack.

11. The membrane electrode assembly according to claim 8, comprising forming an ionomer layer between the catalytic coatings which is in contact with the catalytic coatings of both gas diffusion layers.

12. The membrane electrode assembly according to claim 9, wherein the ionomer layer is in contact with the catalytic coatings of both gas diffusion layers over entire surfaces of the catalytic coatings.

13. The fuel cell according to claim 10, wherein the ionomer coating forms an ionomer layer which is in contact with the catalytic coatings of both gas diffusion layers over entire surfaces of the catalytic coatings.
